(19) United States
(12) Patent Application Publication
(10) Pub. No.: US 2004/0150403 A1
(43) Pub. Date: Aug. 5, 2004

(54) Surface to underwater viewing device attachment for metal detector

(76) Inventor: William Walter Belveal, Pinedale, WY (US)

Correspondence Address: WILLIAM WALTER BELVEAL, PO. BOX 1362, PINEDALE, WY, 82941, US

(21) Appl. No.: 10/351,843

(22) Filed: Jan. 28, 2003

(51) Int. Cl. G01V 3/10

(52) U.S. Cl. 324/327; D10/75

(57) ABSTRACT

A Surface to Underwater Viewing Device Attachment for a Metal Detector. A tube, with clear sheet glass cut to shape and inserted and sealed in one end to make it waterproof, the other end being left open. The tube is long enough to keep the opened end out of the water. The tube is mounted a small distance from, and attached to, the body of the metal detector. The tube is positioned parallel, or almost parallel, at angles that allow the operator to see through the tube, while holding the metal detector. The operator may now see clearly below the surface of the water and see where the search coil on the metal detector has passed over.

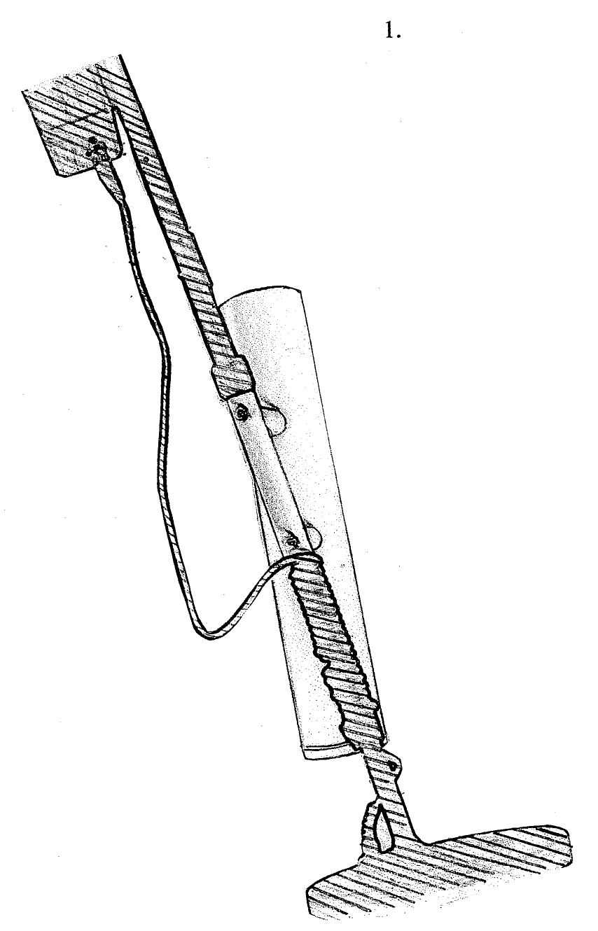

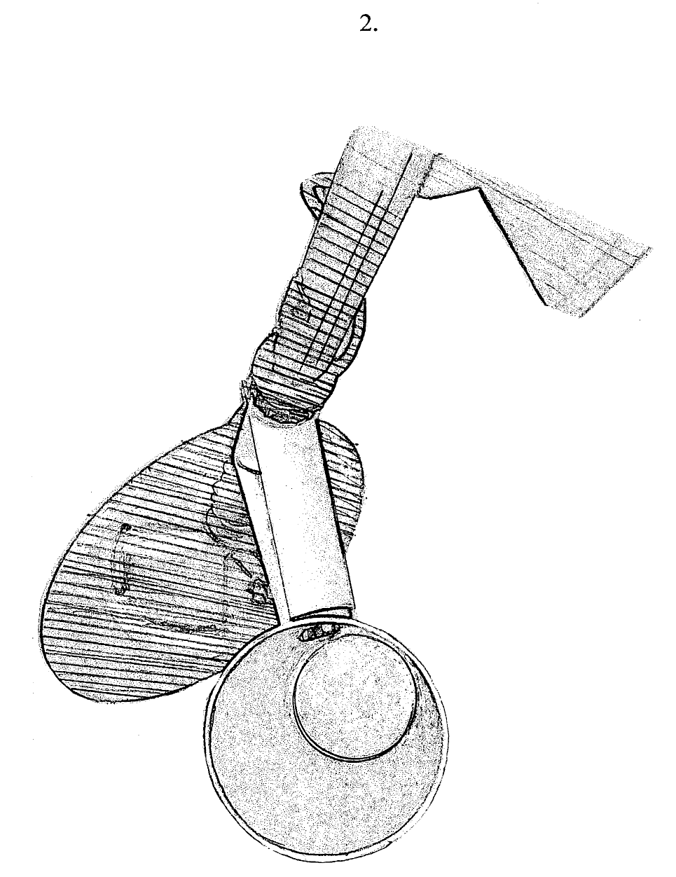

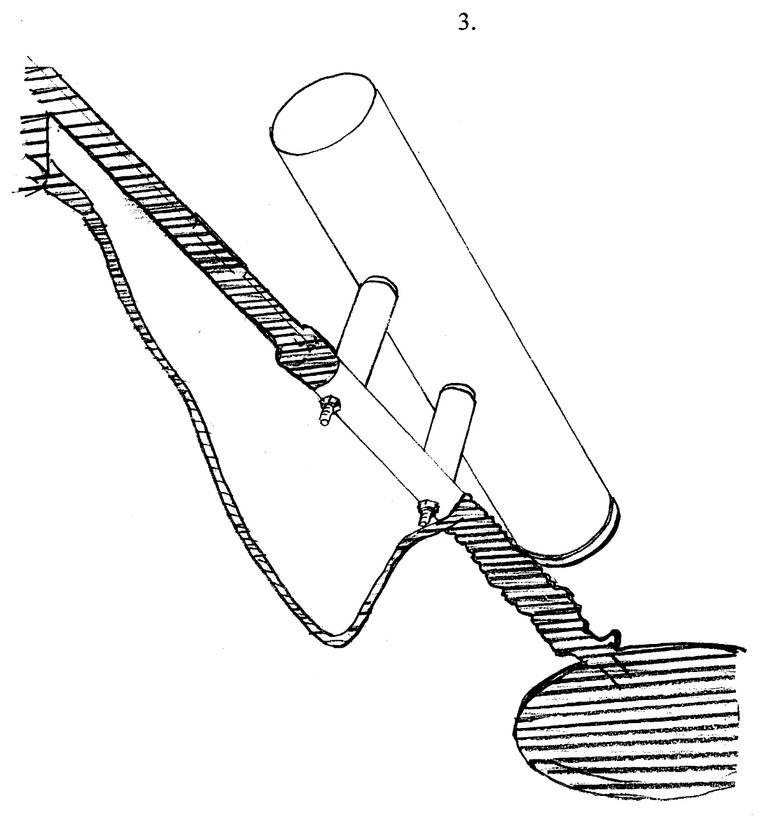

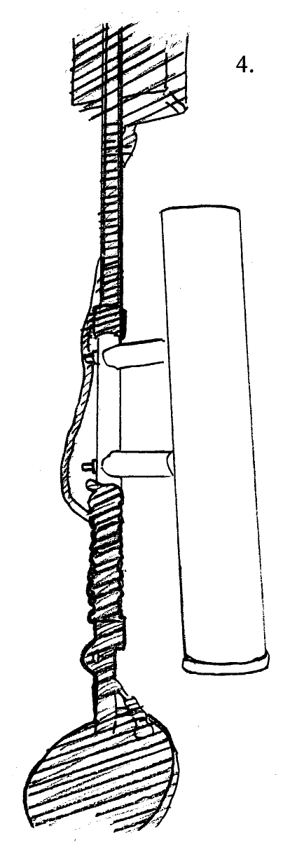

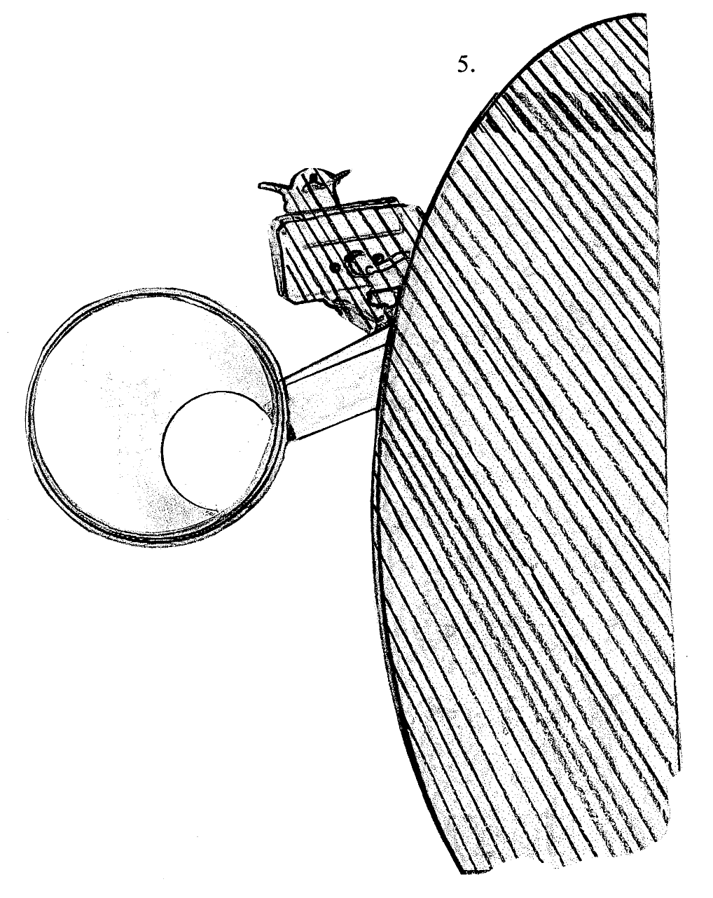

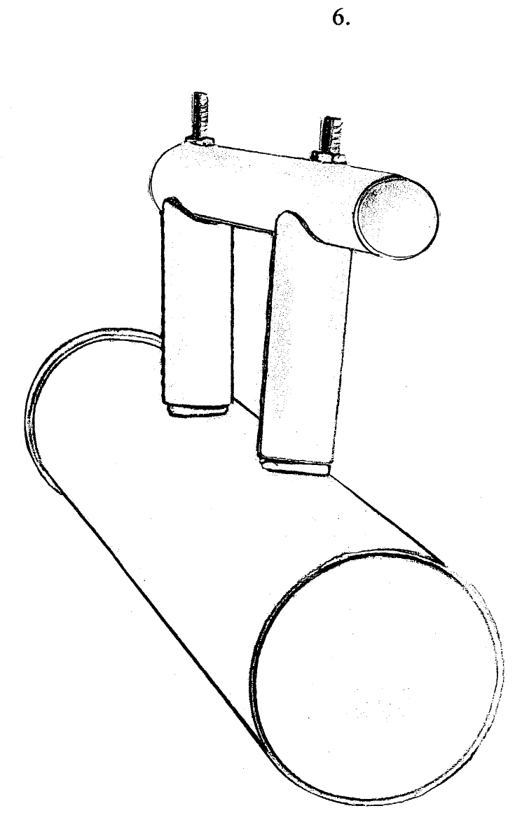

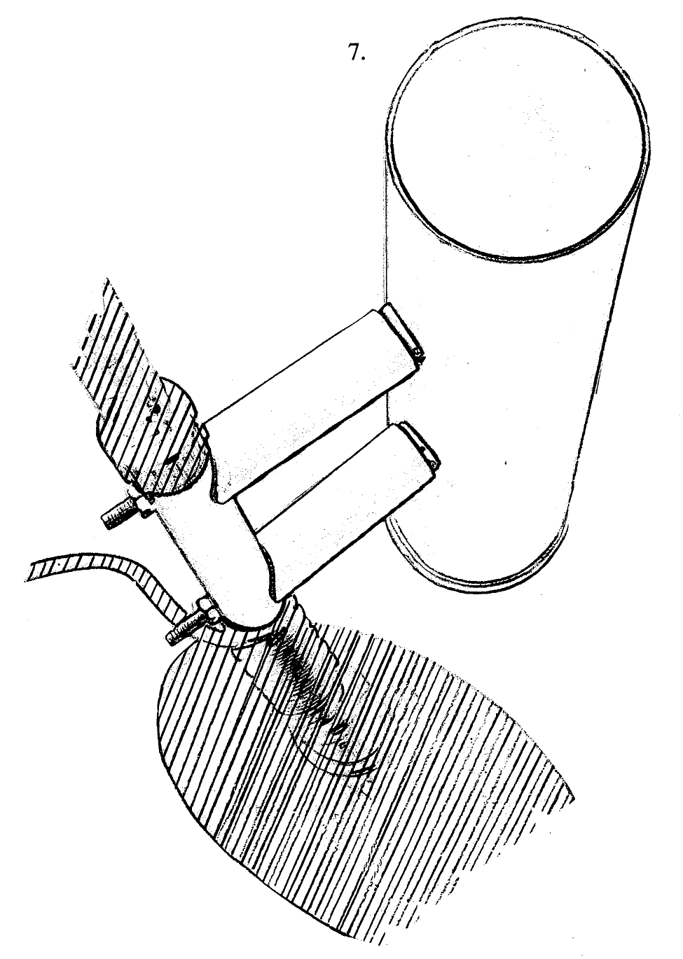

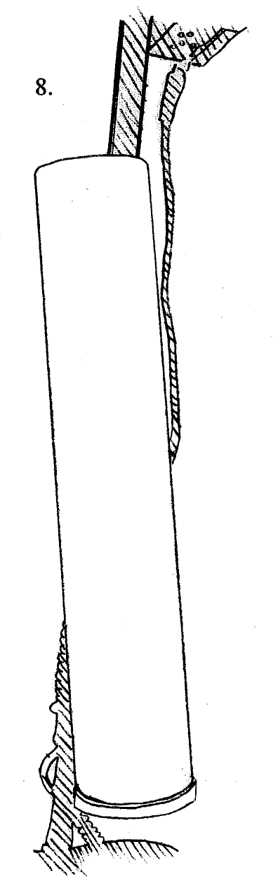

### DRAWINGS

Legend: All areas crossed hatched depict the Metal Detector.

Drawing number 1: Showing parallel, or almost parallel and and set of angle.

Drawing number 2: Top view lookong down through the tube of the device.

Drawing number 3: View of the device as seen from the right side, shows mount bracket and viewing tube.

Drawing number 4: View from the left front side.

Drawing number 5: View from bottom showing glass inserted and sealed to make waterproof. The search coil of the metal detector in cross hatching is on the right side of the page.

Drawing number 6: Device without metal detector.

Drawing number 7: Prospective from the right side.

Drawing number 8: Viewing tube as seen from the right side.

What is claimed is:

1: A Surface to Underwater Viewing Device Attachment for a Metal Detector. An attachment or accessory that mounts on a metal detector comprising of: A tube, with a clear sheet glass cut to fit, inserted, and sealed on one end, to make it waterproof. The other end of the tube is left open. The tube is long enough to keep the open end out of the water when attached to the metal detector. The tube is mounted a small distance away from, and attached to, the body of the metal detector. The tube is positioned parellel, or almost parallel, and at an angle, to allow the operator to see through the tube while holding the metal detector. The operator may now see clearly below the surface of the water and see where the search coil on the metal detector has passed over.

2: A Surface to Underwater Viewing Device Attachment for a Metal Detector as recited in claim # 1. The tube mount may slide over the metal detector body for mounting, or may be attached by none metalic bolts, clips, clamps or other none metalic attaching devices.

3: A Surface to Underwater Viewing Device Attachment for a Metal Detector as recited in claim # 1. The tube and the tube mount may be comprised either by construction or by pressure injection.

4: A Surface to Underwater Viewing Device Attachment for a Metal Detector as recited in claim#1. The tube and tube mount may be injected to include the lower body of the metal detector as all one unit.

5: A Surface to Underwater Viewing Device Attachment for a Metal Detector as recited in claim #1. The tube may be adjustable to the mount, to slide up and down for operators preferences.

6: A Surface to Underwater Viewing Device Attachment for a Metal Detector as recited in claim #1. To off set the boyancy of the larger devices, a counter weight of suffecient weight made of a none metalic material may be attached to the mounting bracket.

7: A Surface to Underwater Viewing Device Attachment for Metal Detector as recited in claim # 1 To off set boyancy, a strap may be fitted over the forearm saddle on the top of the Metal Detector.

8: A Surface to Underwater Viewing Device Attachment for a Metal Detector as recited in claim # 1. The tube with tube mount may be remove from the metal detector, and used independent for surface to underwater viewing.
